(19) United States
(12) Patent Application Publication
(10) Pub. No.: US 2004/0209563 A1
(43) Pub. Date: Oct. 21, 2004

(54) Device for accepting coins

(75) Inventors: Norbert Miller, Monchengladbach (DE); Peter Hoffges, Monchengladbach (DE)

Correspondence Address: CANTOR COLBURN, LLP, 55 GRIFFIN ROAD SOUTH, BLOOMFIELD, CT, 06002

(73) Assignee: Scheidt & Bachmann, Monchengladbach (DE)

(21) Appl. No.: 10/775,568

(22) Filed: Feb. 10, 2004

(30) Foreign Application Priority Data
Apr. 15, 2003 (DE) 103 17 397.8

(51) Int. Cl. G07D 3/00

(52) U.S. Cl. 453/6

(57) ABSTRACT

A process for acceptance of coins in automatic payment transactions is provided, including leading, coins to at least one pair of rollers for the separation of the coins. A device for acceptance of coins in automatic payment transactions is also provided, including a pair of rollers where each rollers where each roller is rotated in the same direction and means of transportation through which the coins are supplied to the pair of rollers.

The present invention concerns a process for accepting coins and for the execution of this process.

A multitude of payment systems are known in economic transactions, in particular automatic devices with which a customer can receive goods and/or services against payments with cash, tokens and such. The automatic device accepts the means of payment, checks its value and validity, and takes the means of payment found to be valid to a repository where the means of payment are stored. Such payment systems are often used for sale of tickets for example, for the transport of passengers.

Known payment systems such as a sales automat for the sale of tickets for public transportation usually have an opening in which the means of payment can be inserted individually in series. The individual means of payment like coins or such are checked and held in an intermittent storage until the amount of the inserted means of payment corresponds to the price of the ticket or exceeds it. The insertion of the means of payment requires usually a correspondingly expenditure of time because each individual insertion locks the insertion opening for the insertion of new means of payment until the verification of the inserted means of payment is completed and has been found as valid. The individual insertion of coins is also unwieldy for the customer as the coins must be inserted individually in a predetermined position corresponding to the opening of the insertion unit. A one-hand operation is usually impossible for the customer and involves the risk if it is done by one hand that coins will fall from the customer's hand and that they will be lost. The operating expenditure from the customer's view is, therefore, too high and uncomfortable. In addition, often specifiable time limits are defined for the payment process, and a new start by the customer is required if the time limits are exceeded.

Even a sales office in public means of transportation is usually associated with these disadvantages. The sale of tickets by the driver of a public means of transportation usually requires that the customer give his fare directly to the driver or deposits it in an area designed for it. It is henceforth the task of the driver to sort the money in his cash box and to determine the amount. This process has the disadvantage for the driver that a multitude of outside influences can lead to the fact that he cannot concentrate and that errors occur during accounting.

It is, therefore, the objective of this invention to refine a representative process and a device in such a way that a customer-friendly simplification can be achieved while maintaining a high state of security.

As a solution, a process for the acceptance of coins during automatic payment transactions is suggested whereby the coins are lead to at least one synchronous roller pair for separation. Advantageously the coin resting on a roller is pulled in the opening by the two rollers while the opposite roller moves the coin resting upon it out of the opening area. With this method, the separation of the coins passing the gap between the two rollers can be achieved. A cumbersome operation through the insertion of individual coins can be avoided with an appropriately designed opening slot. In addition, the insertion and the authentication of the coins can be accelerated. Overall, an acceleration of the payment process can be achieved. The coins can, for example, be fed to the roller pair through a means of transport, whereby both rollers can be rotated in the same direction so that one roller pulls in the coin resting upon it into an opening, while the two rollers and the opposite roller can remove the abutting coin from the opening area. The acceptance means could be designed, for example, with and end funnel or an slanted supporting plane where the coins slide in the direction of the rollers on the basis of their weights. It can also be provided for that the coins are transported through a conveyor belt to the transportation means from where they reach the pair of rollers. The area of the means of transport should be advantageously large for the acceptance of the largest possible number of coins. The rollers can rotate at the same rotational speed or at different rotational speeds. Furthermore, the rollers can have different diameters of surface characteristics, which are adjusted, for example to the anticipated function of pulling the coins into the slot and removing them from the opening area.

It is also suggested that the rollers be rotated with the same rotational speed. That way an especially simple drive of the rollers can be achieved. The rollers can, however rotate also at different rotations speeds.

Furthermore, it is suggested that the coins be conveyed to the pair of rollers. The pair of rollers can be located advantageously in a non-accessible area protecting them from a non-authorized access.

It is suggested in another configuration that the pair of rollers be rotated as a function of the coin supply. It can, for example be provided for that the roller pair only rotates as long as coins are transported to the roller pair. Thus, energy can be saved, and wear and tear can be reduced.

It is in addition suggested that the coins be collected in a container. The coins can be led advantageously into a safe area where it is protected from unauthorized access.

According to another aspect of the present invention, it is suggested that the coins be transported serially from the pair of rollers to a further processing device. The coins can advantageously be fed to the further processing device as needed, where, for example, a serial authentication of the coins could take place.

It is suggested in another configuration that the coins can pass by the further processing device through a bypass. Thus, for example, in the event of a disturbance of the further processing device, it can be guaranteed the coins will not lead to coinage congestion within the device. The coins can, for example, be fed again to an output unit.

It is suggested according to a further aspect of the present invention that the coins pass by the pair of rollers through a bypass connected with the coin slot. Advantageously, coins can still be fed in when there is a disturbance of the pair of rollers.

With the invention, a device for the accepting coins is suggested for automatic payment transactions comprising a pair of rollers whose rollers rotate in the same direction and a means of transport with which the coins are led to the pair of rollers for separation. It is also possible with the present invention to supply coins simultaneously for the execution of a payment transaction of the amount to be paid. The cumbersome handling of individual coins can be avoided with an appropriately designed opening slot. The insertion and the authentication of coins can be accelerated. Overall an acceleration of the payment process can be achieved. The means of transportation can be in the form of an inclined plane, which can be in the form of an end funnel or as an slanted support plane where the coins slide towards the pair of rollers due to their weight. It can also be provided for that the coins are transported through a conveyor belt to an inclined plane from where they reach the pair of rollers. The area of the slanted plane is advantageously so large that it can accept the largest possible amount of coins. In addition, the rollers can have different diameters and surface characteristics, which are adapted, for example, to the anticipated function of pulling the coins in from the slot or removing them from the opening area.

It is also suggested that the distance between the rollers is larger than the thickness of one coin and smaller than the thickness of two coins. With this method it can be advantageously avoided that two coins pass the opening between the rollers simultaneously and that they reach the next functional area. As long as two coins next to each other abut the rollers one coin will be pulled into the opening area by a roller while the opposite coin is removed from the opening area by the opposite roller counter the flow direction. Thus a safe separation of the coins can be achieved.

The means of transport can be in form of an inclined support. The transport can be performed advantageously with little or no additional use of energy. It can, however also be a conveyor belt, a vibration conveyor or the like.

It is an aspect of this invention that the device can be equipped with a further processing device. The further processing device can be, for example, a coin tester that authenticates the coins and designates them as a valid or invalid means of payment. The further processing device could also contain a calculator unit with which the amount of the authenticated coins is determined as a total. The further processing device can also contain other or additional tasks.

The device can be equipped with a bypass to circumvent the further processing device. It can be guaranteed with a bypass that the coins will be passed by the further processing device in case of

a disturbance and can be fed for example to a coin ejector device or to another container. With this method, it can be avoided that the further processing device is additionally damaged through the insertion of an ever greater number of coins.

The device can also be quipped with a coin insertion slot that can be locked. It can be guaranteed that no additional coins or even unauthorized objects can be inserted in the insertion area of the device in the event of a disturbance. This way, additional damage can be avoided. It can also be provided that the opening area is locked if there is a disturbance of the device overall. A computer can control the locking mechanism.

Furthermore, the coin insertion slot can be constructed funnel-like. With a funnel design a simple supply of the coins to the pair of rollers can be achieved. Based on the force of gravity, the coins slide into the area of the pair of rollers. Conveyors such as conveyor belts or the like can also be used with low funnel gradients.

According to one aspect of the invention, the coin insertion slot can have an area for individual insertion of coins. An individual insertion of coins can be advantageously ensured in the event of a disturbance of insertion through the pair of rollers so that operation is also guaranteed in the event coin acceptance through the pair of rollers is disturbed. The area for the individual insertion of the coins can be lockable, for example, whereby a computer unit can control the lock.

It is also suggested that the area for individual coin insertion can be blocked and/or released. The area for individual coin insertion can only be unblocked if the device detects a disturbance in coin acceptance through the pair of rollers through a self-diagnosis of the device. After eliminating the disturbance, the area of the individual insertion can be blocked again automatically. It also can be provided that there is a manual blocking and/or releasing device.

Furthermore, it is suggested that the device is equipped with a sensor for recognizing a coin insertion. Thus, the pair of rollers can be advantageously be on standby, saving energy and without drive, whereby the pair of rollers will only be driven after a coin insertion has been detected. The coin insertion slot can be designed with a weight sensor or with an electrical or magnetic field sensor. An optical sensor can also be provided in order to recognize a coin insertion. As soon as a coin insertion has been detected the appropriate pair of rollers is put into motion.

Furthermore, it is suggested that the individual coin insertion area be connected to a bypass to circumvent the roller pair. In event of a disturbance in the supply of coins through the pair of rollers, coins can still be fed in despite this disturbance.

The function of the device is advantageously independent from the function of the pair of rollers.

Means of transportation can be placed between the pair of rollers and the further processing device. The means of transportation can be formed, for example through a slanted plane or through transport belts or pipes. The individual coins can be supplied advantageously to the further processing device so that the coins can be selectively authenticated.

In addition, it is suggested that the means of transportation be a slanted plane. The slanted plane can be advantageously designed in such a way that the coins remain separated for further processing.

In order to repair a disturbance in the means of transportation, providing a removable and/or pivotal cover in the area of the means of transportation is suggested. A penetration of contaminants or undesired particles can be avoided advantageously with the cover.

It is further suggested that sensors are provided for in the area of the means of transportation to capture contaminants. These sensors can be connected with the drive of the means of transportation cover through a computer so that the cover can be activated and actuated for the removal of the undesired contaminants.

The contaminants as well as defective coins or invalid coins can be detected advantageously before major damage to the device has arisen. Through blocking of the coin insertion slot as well as of the individual coin insertion area, the automatic device can be protected to a greater extent from more serious damage.

Within the framework of the present invention individual characteristics can be combined to additional configurations.

Additional advantages and characteristics can be gathered from the following description of an embodiment with reference to the drawing. The drawing is a schematic drawing and only serves to explain of the following design example and is not limiting.

The only Figure shows a schematic representation of an embodiment of a coin acceptance device.

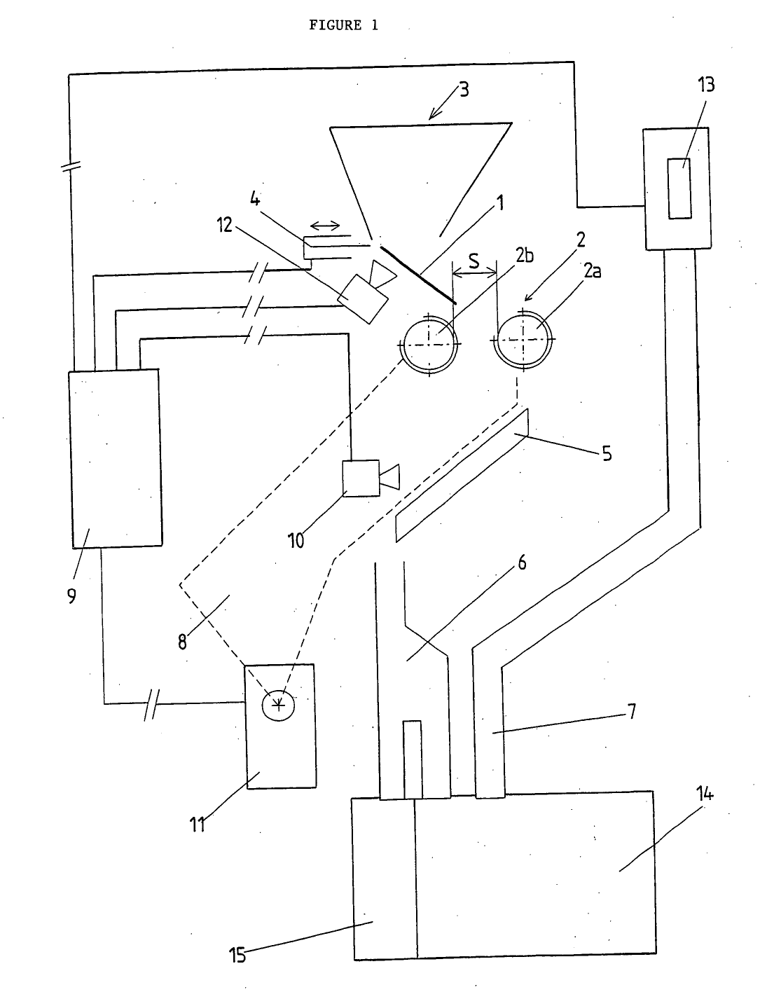

In FIG. 1, one recognizes a slanted plane for the supply of individual coins to a pair of rollers whose rollers 2a, 2b rotate in the same direction, for example, clockwise. The slanted plane 1 is a part of the acceptance funnel 3 in the shown design example, where a random number of coins can be inserted where they are arranged advantageously. The funnel 3 can be locked at the bottom area with the help of a trap 4.

With an open trap 4, the inserted coins are supplied through a slanted plane 1 to the pair of rollers 2 whose rollers 2a and 2b are located at a distance from each other. The distance between the rollers 2a and 2b is designated with the measurement s. This measurement s is large than the thickness of the thickest coin but smaller than the double thickness of the thinnest coin. The selection of the distance s between the rollers 2a, 2b guarantees that only one coin can pass the slot between the rollers 2a, 2b regardless of its value. Due to the same rotational direction of the rollers 2a, 2b, the roller 2b will move the coins into the slot s, while the roller 2a will remove the coins due to the peripheral speed at slot s that is counter to the flow direction of the coins. In case two or more coins arrive simultaneously at the slot s, only the coin that comes in contact with roller 2b will be conveyed through slot s while the coin coming into contact with the roller 2a will be thrown back from the slot and will only be able pass the slot later. After passing the pair of rollers 2, the coins arrive at another slanted plane 5 where they are led to further processing, for example to a coin tester 6. In case that there is a disturbance at the coin tester 6, a bypass 7 is provided to circumvent the coin tester 6. In order to prevent the penetration of contaminants in the coin tester 6 a perforated trap 8, for example, is located above the slanted plane 5, which can be opened or closed through a control 9. A sensor 10 that can differentiate between an inserted coin and an undesired contaminant and that is also connected to the control 9 will send a control signal to the control 9 that is processed there if a contaminant is present on the area of the slanted plane 5 and a signal to open or close the trap 6 is forwarded to the drive 11 of the trap 8. The control 9 is connected to another sensor 12 that is located in the area of the slanted plane 1 of the funnel 3 and that can register a coin insertion and send a signal to control 9. The lock 4 of the slanted plane 1 can also be opened and closed through the control 9. With a closed trap 4 the control 9 sends a signal to the coin insertion slot 13. This coin insertion slot 13 is closed with an open trap 4 and will be opened through the signal of control 9 when the trap 4 is closed. With this method individual coins still are guaranteed to be accepted even when there is a failure in the area of the coin separation. The coins inserted into the device are either collected after a test in the coin tester 6 in a container 14 or—in case of invalid coins—forwarded coin rejection unit 15.

The description of the Figure serves exclusively to explain the current invention and is not restrictive for it.

### Reference Number List:

1 slanted plane

2 rollers

2a rollers

2b rollers

3 funnel

4 trap

5 slanted plane

6 coin tester

7 bypass

8 trap

9 control

10 sensor

11 drive

12 sensor

13 coin insertion slot

14 container

15 coin ejection unit

s slot

1. Process for acceptance of coins in automatic payment transactions, comprising: leading the coins to at least one pair of rollers for separation of the coins.

2. Process according to claim 1, wherein the rollers are rotated at the same rotational speed.

3. Process according to claim 1, wherein the coins to the pair of rollers.

4. Process according to claim 1, wherein the pair of rollers is rotated as a function coin supply.

5. Process according to claim 1, wherein the coins are collected in a container.

6. Process according to claim 1, wherein the coins are conveyed in series from the pair of rollers to a further processing device.

7. Process according to claim 6, wherein the coins are passed by the further processing device through a bypass connected to a coin insertion slot.

8. Process according to claim 1, wherein the coins are passed by the pair of rollers through a bypass connected to a coin insertion slot.

9. Device for acceptance of coins in automatic payment transactions, comprising: a pair of rollers where each rollers is rotated in the same direction; and means of transportation through which the coins are supplied to the pair of rollers.

10. Device according to claim 9, wherein a distance between the rollers is greater than a thickness of one coin and smaller than a thickness of two coins.

11. Device according to claim 9, wherein the means of transportation comprises a slanted plane.

12. Device according to claim 9, further comprising a further processing device.

13. Device according to claim 12, further comprising a bypass to circumvent the further processing device.

14. Device according to claim 9, further comprising a coin slot that can be locked.

15. Device according to claim 14, wherein the coin insertion slot is constructed funnel-like.

16. Device according to of claim 14, wherein the coin insertion slot has an area for individual insertion of coins.

17. Device according to claim 16, wherein the individual coin insertion area can be blocked and released.

18. Device according to claim 16, wherein the individual coin insertion area is connected with a bypass to circumvent the pair of rollers.

19. Device according to claim 9, further comprising a sensor for recognizing a coin insertion.

20. Device according to claim 12, wherein the means of transportation is located between the pair of rollers and the further processing device.

21. Device according to claim 9, wherein the means of transportation is a slanted plane.

22. Device according to claim 9, further comprising a removable and/or pivotal cover located in an area of the means of transportation.

23. Device according to claim 9, wherein a sensor is located in an area of the means of transportation for capturing contaminants.
